(19) United States
(12) Patent Application Publication
(10) Pub. No.: US 2025/0243415 A1
(43) Pub. Date: Jul. 31, 2025

(54) BIO OILS

(71) Applicant: ASTON UNIVERSITY, Birmingham West Midlands (GB)

(72) Inventors: Jude ONWUDILI, Birmingham West Midlands (GB); Cristiane SCALDAFERRI, Birmingham West Midlands (GB)

(21) Appl. No.: 18/854,302

(22) PCT Filed: Apr. 6, 2023
(86) PCT No.: PCT/GB2023/050924

§ 371 Date: Oct. 4, 2024

(30) Foreign Application Priority Data
Apr. 6, 2022 (GB) 2205031.4

(51) Int. Cl. C10G 3/00; C10G 31/09; C10G 53/02; C10G 65/04

(52) U.S. Cl. CPC C10G 3/50; C10G 31/09; C10G 53/02; C10G 65/04; C10G 2300/1011

(57) ABSTRACT

A two-stage method for producing a biofuel, the method comprises: a first stage of heating bio-oil, organic solvent and non-oxygenating gas in the presence of a solid catalyst; providing a liquid output from the first stage; and a second stage of heating an organic liquid component derived from the liquid output and non-oxygenating gas in the presence of a solid catalyst.

This invention relates to pyrolysis bio-oils and specifically, although not exclusively, to the use of bio-oils in blended liquid fuels.

It is desirable to reduce the world's reliance on fossil fuels, not least because of local, regional and global environmental issues pertaining to the production and use of fossil fuels.

In many countries around the world fossil fuel use continues to rise (USA fossil fuel consumption 1965-2019 increased from 14×10³ TWh to 21.8×10³ TWh per year). Whilst there have been many developments in alternative energy sources for stationary power generation (wind, solar, tidal etc) fossil fuel consumption continues to increase in many countries of the world (e.g. USA electricity generation from fossil fuels 1985-2020 increased from 1.9 TWh to 2.4 TWh per year, albeit down from 2007's peak of 3 TWh).¹

Further, whilst many developments have been made in the electrification of transport, fossil fuels remain the dominant energy source for transport (New passenger vehicles UK 2019, 63% petrol, 27% diesel, 7% full hybrid, <2% battery, <2% plug in hybrid).¹

Although the uptake of electric road vehicles is increasing, the overall energy mix of fossil fuels to electric (and/or hydrogen) is unlikely to change substantially over the next few years. Moreover, other forms of transport (for example aircraft and seacraft) are substantially behind road vehicles in the deployment of electric alternatives to fossil fuels, although technological development has ensured that carbon emissions have not increased in line with air traffic increases (kgCO₂ per revenue passenger kilometre 1960-2018 decreased 11-fold).¹

Accordingly, there is a continuing need to find replacements or substitutes for fossil fuels to mitigate environmental concerns.

One such potential replacement or substitute is biomass pyrolysis oil or bio-oil which is obtained by heating dried biomass under oxygen-free or air-free or non-oxidizing conditions in a reactor. Feedstocks typically comprise wood and plant residues. The products of this pyrolysis process are solid (biochar), liquid (bio-oil) and gaseous (syngas). ¹ Ritchie and Roser (2020)—“Energy”. Published online at OurWorldInData.org. ‘https://ourworldindata.org/energy’

Although the process is carried out in the absence of oxygen, bio-oils normally contain high levels of oxygen from the oxygen content of the biomass feedstock, which can be above 40% by weight. This level of oxygen in bio-oils makes them different to pure hydrocarbons derived from fossil fuels. This high oxygen content results in non-volatility, corrosiveness, immiscibility with fossil fuels, thermal instability, and a tendency to polymerize when exposed to air and during storage. Bio-oils exiting the pyrolysis reactor also contain relatively large amounts of water, sometimes more than 20 wt %.

Because of the chemical nature and physical properties of bio-oils there is not currently a substantial commercial market, although bio-oil can be used in boilers and furnaces. In order to make bio-oil useful as a replacement for fossil fuel derived energy sources it is necessary to remove the oxygen. The process of removing oxygen from bio-oil is known as upgrading.

There are many methods which have been proposed for obtaining valuable products from bio-oils, which might be broadly classified in four categories: physical; chemical; co-pyrolysis; and physical-chemical refining.² Of these, hydrodeoxygenation (HDO) is a process which uses significant amounts of hydrogen (pressures of up to 100 bar) to remove oxygen from the bio-oil. An example of an HDO process is described in US2007/0131579 which discloses, in its examples, an HDO process for soybean oil which uses hydrogenation pressures of 5 MPa (50 bar) over a NiMo/Al₂O₃ catalyst.

However, this process uses large amounts of excess hydrogen which can increase processing costs and can result in extensive carbon loss from the bio-oil due to char formation. Accordingly, conventional HDO typically results in low yields, is expensive and requires equipment capable of handling the high pressures of hydrogen required.

Low pressure hydrogen solutions have been proposed using a molybdenum oxide catalyst^{3,4} but these were either at very small scale, did not lead to total deoxygenation or suffer from excessive char formation.

Accordingly, it would be highly beneficial for a new upgrading process which did not suffer from one or more of the problems of the prior art. ² Energy Procedia 61 (2014) 1306-1309³ https://pubs.rsc.org/en/content/articlelanding/2016/GC/C5GC01614B⁴ https://pubs.rsc.org/en/content/articielanding/2017/GC/C7GC01477E

A first aspect of the invention relates to a method of upgrading bio-oils, the method comprising a first stage of introducing bio-oil, an organic solvent and a non-oxygenating gas into a reactor and contacting the bio-oil, organic solvent and non-oxygenating gas with a solid catalyst at a temperature in the range of 100 to 500° C. for, say, up to 10 hours.

The method may comprises contacting the bio-oil, organic solvent and non-oxygenating gas with a solid catalyst for 1 to 10 hours, say from 2, 3, 4, 5, 6, 7, 8, 9 hours to any one of 10, 9, 8, 7, 6, 5, 4, 3, 2 hours. In an embodiment the method comprises contacting the bio-oil, organic solvent and non-oxygenating gas with a solid catalyst for 2 to 5 hours.

The method may comprise contacting the bio-oil, organic solvent and non-oxygenating gas with a solid catalyst at temperatures of from 200 to 350° C.

The method may further comprise separating the product of the first stage into gaseous, solid and liquid components.

The method may further comprise dewatering the liquid component to provide an organic component.

The method may further comprise a second stage of contacting the organic component with a solid catalyst in the presence of a non-oxygenating gas at a temperature in the range of 100 to 500° C. for, say, up to 5 hours, for example 200-350 for up to 4 hours.

The method may further comprise separating the product of the second stage into gaseous, solid and upgraded liquid components.

The upgraded liquid component may be directly used or further mixed with a fuel source, for example a conventional fuel, to produce a blended biofuel.

A further aspect of the invention provides a two-stage method for producing a biofuel, the method comprising:
a first stage of heating bio-oil, organic solvent and non-oxygenating gas in the presence of a solid catalyst;
providing a liquid output from the first stage; and
a second stage of heating an organic liquid component derived from the liquid output and non-oxygenating gas in the presence of a solid catalyst.

The first stage may further comprise a subsequent separating stage to separate the output into gaseous, solid and the liquid output. The subsequent separating stage may comprise a filter.

The second stage may further comprise a subsequent separating stage to separate the output into gaseous, solid and the upgraded liquid component. The subsequent separating stage may comprise a filter.

The upgraded liquid component may be used directly as a fuel or mixed with a fuel source, for example a conventional fuel, to form a blended biofuel.

The method may further comprise dewatering a liquid output from the first stage to form the or an organic liquid component.

The first stage may comprise providing as the non-oxygenating gas hydrogen, nitrogen, argon, helium or mixtures of the same.

The non-oxygenating gas of the first stage may be provided at pressures of less than 30 bar (3.0 MPa), for example from 5 to 25 bar (0.5-2.5 MPa), say from 10-20 bar (1-2 MPa).

The first stage may comprise heating from 100-250° C., for example from one or 100, 110, 120, 130, 140, 150, 160, 170, 180, 190, 200, 210, 220, 230, 240° C. to one of 250, 240, 230, 220, 210, 200, 190, 180, 170, 160, 150, 140° C. for a first time period and heating from 250-500°, for example from 250° C. to 500, 490, 480,470, 460, 460, 440, 430, 420, 410, 400, 390, 380, 370, 360, 350, 340, 330, 320° C., for a second time period. The first time period may be from 1 to 5 hours, say 2 to 4 hours. The second time period may be from 1 to 5 hours, say from 2 to 4 hours. In an embodiment the first period is 3 hours. In an embodiment the second period is 3 hours.

The first stage may comprise providing as the organic solvent a hydrocarbon with from 8 to 20 carbons. The organic solvent is preferably aliphatic. The organic solvent may be branched or unbranched. In an embodiment the hydrocarbon may be a C₁₀ to C₁₅ hydrocarbon, for example a C₁₀-C₁₅ aliphatic hydrocarbon, for example a C₁₀ to C₁₅ unbranched hydrocarbon, for example a C₁₀ to C₁₅ unbranched aliphatic hydrocarbon. In an embodiment the organic solvent may be dodecane.

The bio-oil (B) and organic solvent (O) may be provided in weight ratios of from 10:90 to 90:10, for example from 80:20 to 20:80, say 70:30 to 30:70 or from 65:35 to 35:65. In an embodiment the ratio is 60:40 O:B. In an embodiment the organic solvent is provided in weight excess of the bio-oil.

The first stage may comprise providing, as the solid catalyst, platinum metal, palladium metal, ruthenium metal, rhodium metal, for example platinum metal on an inert carrier. The inert carrier may be a ceramic material, for example alumina, silica. The inert carrier may be a carbon material, for example, activated carbon, biomass-derived carbon (biochar), biomass-derived activated carbon (activated biochar).

The second stage may comprise providing as the non-oxygenating gas hydrogen, nitrogen or mixtures of the same.

The non-oxygenating gas of the second stage may be provided at pressures of from 5 to 25 bar (0.5-2.5 MPa), say from 10-20 bar (1-2 MPa).

The second stage may comprise heating from 250-500° C., for example from 250° C. to 500, 490, 480,470, 460, 460, 440, 430, 420, 410, 400, 390, 380, 370, 360, 350, 340, 330, 320° C. for, say, from 1 to 5 hours, for example from 2 to 4 hours.

The second stage may comprise providing, as the solid catalyst, platinum metal, platinum metal, ruthenium metal, rhodium metal, nickel metal for example platinum metal on an inert carrier. The inert carrier may be a ceramic material, for example alumina, silica. The inert carrier may be a carbon material, for example, activated carbon, biomass-derived carbon (biochar), biomass-derived activated carbon (activated biochar).

A further aspect of the invention provides a system and/or apparatus for producing a bio-fuel, the system and/or apparatus comprising a first reactor and a first separator and a second reactor and a second separator, the first separator being arranged to separate the products of the first reactor into liquid, solid and gaseous components, the second separator being arranged to separate the products of the second reactor into liquid, solid and gaseous components, the system and/or apparatus comprising a liquid separator to separate the liquid component from the first separator into an aqueous component and an organic component means to convey the organic component to the second reactor.

The first reactor may comprise a bio-oil supply line and an organic solvent supply line and a non-oxygenating gas supply line.

The second reactor may comprise an organic component supply line and a non-oxygenating gas supply line.

A yet further aspect of the invention provides a biofuel, the biofuel comprising a mixture of a bio-oil derived component and a liquid, thermally stable, hydrocarbon solvent (e.g., C₁₀-C₁₅ hydrocarbons, kerosene), wherein the biofuel comprises from 5-95 wt % bio-oil derived component and from 95 to 5 wt % liquid, thermally stable, hydrocarbon solvent (e.g., C₁₀-C₁₅ hydrocarbons, kerosene), water and oxygenated compounds, and wherein the water content is less than 1 wt % and the oxygen content is less than 1 wt %.

Preferably the water content is less than 0.9, 0.8, 0.7, 0.6, 0.5 wt %.

Preferably the oxygen content is less than 0.9, 0.8, 0.7, 0.6, 0.5, 0.4, 03, 0.2 wt %.

Preferably the solids content is less that 0.5, 0.4, 0.3, 0.2, 0.1 wt %. Preferably the solids content is 0 wt %.

In this specification oxygen content is a measurement of the amount of oxygen atoms.

In order that the invention may be more fully understood it will now be described, by way of example only, and with reference to the accompanying drawings in which:

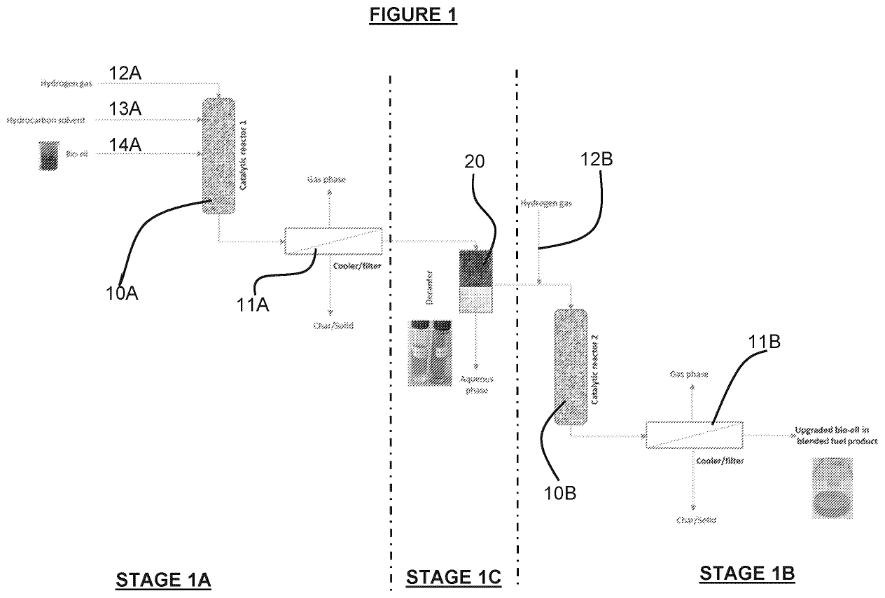

FIG. 1 shows a process flow schematic of the system of the invention;

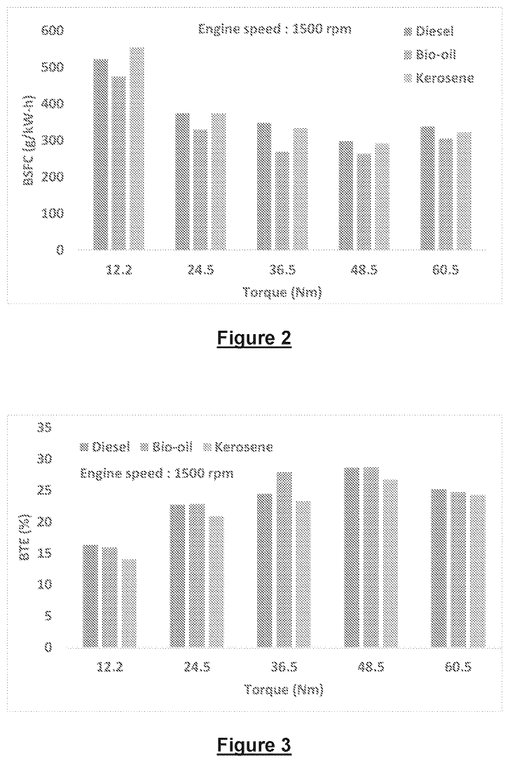

FIG. 2 is a graph showing brake specific fuel consumption results;

FIG. 3 is a graph showing brake thermal efficiency results;

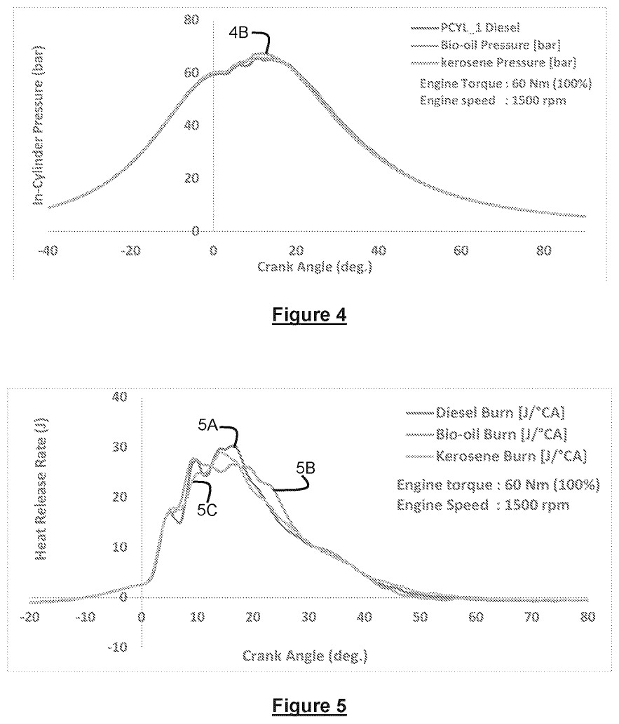

FIG. 4 is a graph showing in cylinder pressure results;

FIG. 5 is a graph showing heat release rate results;

FIG. 6 is a graph showing cumulative heat release rate results;

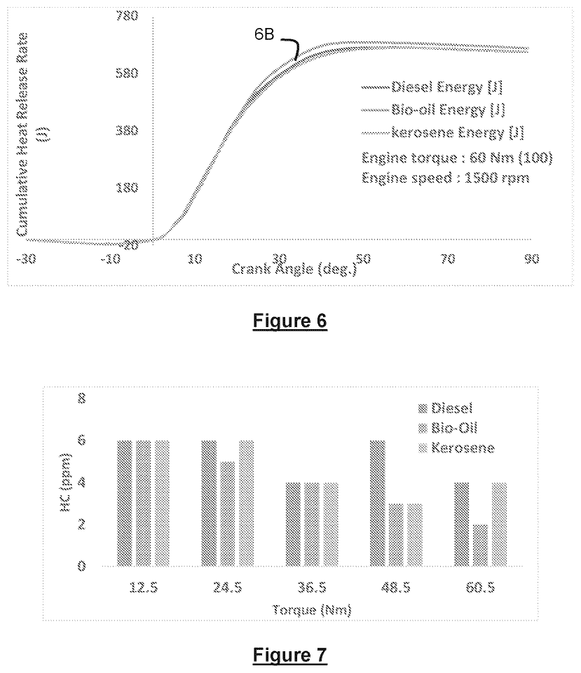

FIG. 7 is a graph showing hydrocarbon emissions results;

FIG. 8 is a graph showing CO emissions results;

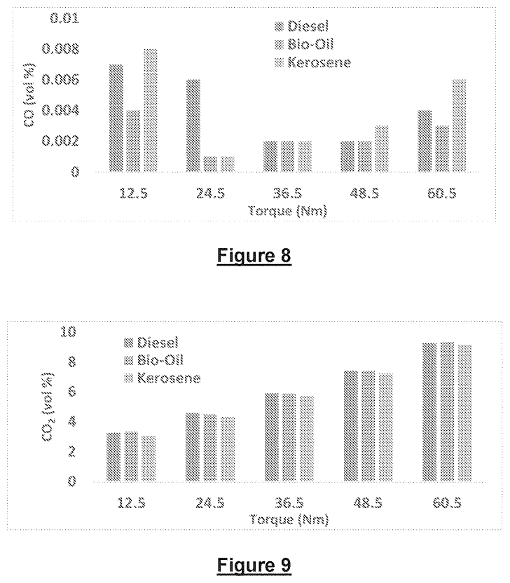

FIG. 9 is a graph showing CO₂ emissions results;

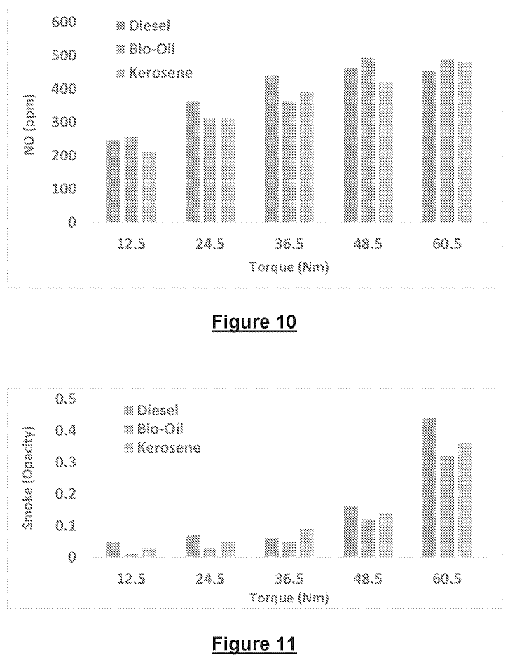

FIG. 10 is a graph showing NO emissions results; and

FIG. 11 is a graph showing smoke emissions results.

Referring first to FIG. 1, there is shown a process flow schematic which identifies the process steps of the system and the apparatus 1 for use in the system. It will be appreciated that the system provides a two-stage upgrading process, stages 1A and 1C.

The first stage 1A comprises a first catalytic reactor 10A and a first filter 11A. There is also provided a gas supply line 12A, a solvent supply line 13A and a biofuel supply line 14A to supply the respective materials to the first reactor.

The first reactor is a packed bed catalytic reactor which is controllably heatable.

The second stage 1C comprises a second catalytic reactor 10C and a second filter 11C. There is also provide a second gas supply conduit 12C. The second reactor 10C is a packed bed catalytic reactor which is controllably heatable.

Between the first stage 1A and second stage 1C is an intermediate, gas-liquid separator followed by liquid separation, stage 1B comprising a liquid separator or decanter 20.

In the first stage 1A bio-oil, a hydrocarbon solvent (for example dodecane) and a non-oxygenating gas (for example hydrogen and/or nitrogen) at 10-20 bar (1-2 MPa) are introduced into the first reactor 10A. The reactor 10A is heated, for example at temperatures up to 500° C. for, say up to 10 hours, preferably at temperatures of 100 to 350° C. for up to 5 hours. The product is passed to the first filter 11A where the material is cooled, and a gas phase and a solid phase (char and other solids) is removed to leave a liquid phase.

The liquid phase output of the filter 11A is passed to the intermediate stage 1B where the organic and aqueous phases are allowed to separate in the decanter 20.

The organic phase from the intermediate stage 1B is introduced to the second reactor 10C of the second stage 1C with hydrogen gas at 10-20 bar (1-2 MPa) and heated at up to say 500° C. for say up to 5 hours.

The stages 1A, B, C may be arranged for batch processing, whereby each operation (i.e. stage 1A, stage 1B and stage 1C) is conducted sequentially or arranged for continuous processing whereby the outputs from stage 1A are conveyed as inputs to intermediate stage 1B and the output of intermediate stage 1B is conveyed to the input of second stage 1C.

The output from the second stage 1C may be mixed with a hydrocarbon fuel, for example diesel as a like-for-like replacement. The mixed product may be subject to a further refining step.

In order that the invention may be further explained, reference is made to the following non-limiting examples, as follows:

### Example 1—First Stage Process

Bio-oil was prepared in-house from a biomass feedstock derived from pine wood.

In the first stage (1A) bio-oil 40 wt % and dodecane 60 wt % were reacted with 10 bar H₂ in contact with 5 g of Pt on Al₂O₃ catalyst (supplied by Catal International Limited). The reactor 10A was heated at 160° C. for 3 hours and then at 300° C. for 3 hours with stirring at 600 rpm. The reactor was a stirred, stainless steel batch reactor with a volume of 450 ml and an internal diameter of 50.8 mm.

The product from the reactor 10A was passed to a separator 11A for the removal of gaseous and solid components. The separator 11A may comprise a gas/liquid separator followed by a liquid filtration stage to remove solids.

The yields (wt %) were as follows:

TABLE 1
Yield after first reactor 10A

| | |
|---|---|
| Solid (%) | 14 |
| Gas (%) | 7 |
| Water (%) | 10 |
| Oil (%) | 69 |

The resultant liquid (oil) was subjected to GC-MS analysis with the following results (excluding dodecane):

TABLE 2
GC/MS Analysis after first stage

| | Retention | % | |
|---|---|---|---|
| Peak# | time | area | Name |
| 1 | 2.091 | 2.99 | 2-Butanone |
| 2 | 2.132 | 0.97 | Furan, 2-methyl- |
| 3 | 2.199 | 0.86 | Ethyl Acetate |
| 4 | 2.321 | 3.41 | Methyl propionate |
| 5 | 2.507 | 0.45 | Cyclopentene, 1-methyl- |
| 6 | 2.585 | 0.61 | 2-Butanone, 3-methyl- |
| 7 | 2.889 | 3.15 | Isobutyl acetate |
| 8 | 3.022 | 0.93 | 3-Pentanone |
| 9 | 3.072 | 0.43 | Furan, 2-ethyl- |
| 10 | 3.409 | 1.39 | Butanoic acid, methyl ester |
| 11 | 3.975 | 0.7 | |
| 12 | 3.999 | 0.68 | |
| 13 | 4.298 | 0.86 | Toluene |
| 14 | 4.695 | 1.06 | Butanoic acid |
| 15 | 4.762 | 0.59 | 3-Hexanone |
| 16 | 4.902 | 1.89 | Cyclopentanone |
| 17 | 6.491 | 3.19 | Cyclopentanone, 2-methyl- |
| 18 | 6.611 | 0.69 | 2-Pentanone, 4-hydroxy-4-methyl- |
| 19 | 6.742 | 0.92 | Cyclopentanone, 3-methyl- |
| 20 | 7.59 | 0.48 | p-Xylene |
| 21 | 8.736 | 0.55 | Cyclohexanone |
| 22 | 9.344 | 1.69 | 2-Cyclopenten-1-one, 2-methyl- |
| 23 | 10.991 | 0.96 | Cyclopentanone, 2-ethyl- |
| 24 | 11.435 | 0.92 | 1,7-Octadiene, 2,7-dimethyl- |
| 25 | 13.827 | 0.73 | Phenol |
| 26 | 14.578 | 1.59 | Decane |
| 27 | 17.119 | 0.47 | 2-Cyclopenten-1-one, 2,3-dimethyl- |
| 28 | 18.494 | 1.86 | Phenol, 2-methyl- |
| 29 | 19.911 | 1.34 | p-Cresol |
| 30 | 20.567 | 8.94 | Phenol, 2-methoxy- |
| 31 | 24.903 | 1.81 | Phenol, 2,4-dimethyl- |
| 32 | 25.03 | 0.57 | |
| 33 | 25.489 | 0.44 | Nonane, 5-(2-methylpropyl)- |
| 34 | 25.795 | 1.32 | Undecane, 2-methyl- |
| 35 | 26.265 | 1.98 | Undecane, 3-methyl- |
| 36 | 26.825 | 1.01 | 2-Methoxy-5-methylphenol |
| 37 | 27.843 | 9.82 | Creosol |
| 38 | 33.887 | 4.8 | Phenol, 4-ethyl-2-methoxy- |
| 39 | 35.31 | 11.65 | Tridecane |
| 40 | 39.848 | 7.05 | Phenol, 2-methoxy-4-propyl- |
| 41 | 41.972 | 0.93 | Tetradecane |
| 42 | 63.173 | 1.22 | 1-Phenanthrenecarboxaldehyde, |
| | | | 1,2,3,4,4a,9,10,10a-octahydro-1,4a- |
| | | | dimethyl-7-(1-methylethyl)-, [1S- |
| | | | (1.alpha.,4a.alpha.,10a.beta. |
| 43 | 63.304 | 0.79 | |
| 44 | 63.748 | 1.51 | 1-Phenanthrenecarboxaldehyde, |
| | | | 1,2,3,4,4a,9,10,10a-octahydro- |
| | | | 1,4a-dimethyl-7-(1-methylethyl)-, |
| | | | [1S-(1.alpha.,4a.alpha.,10a.beta. |
| 45 | 64.605 | 0.5 | 9-Octadecenoic acid, methyl ester, (E)- |
| 46 | 64.874 | 1.56 | 10,18-Bisnorabieta-5,7,9(10),11,13-pentaene |
| 47 | 64.995 | 0.45 | |
| 48 | 66.464 | 3.09 | Retene |
| 49 | 66.992 | 0.86 | |
| 50 | 67.868 | 2.63 | Methyl dehydroabietate |
| 51 | 70.52 | 0.72 | |

The oil yield from the first stage was 69 wt %. The upgraded bio-oil yield of the first stage oil was 24% (corresponding to 14 wt % of the oil).

### Example 2—Second Stage Process

After separating the aqueous phase from the organic phase of the liquid output from the first stage in a separator 20, the resulting organic phase (oil) was introduced into a reactor 10C and reacted with 10 bar H₂ in contact with 5 g of Pt on Al₂O₃ catalyst (supplied by Catal International Limited). The reactor 10A was heated at 300° C. for 3 hours with stirring at 600 rpm. The reactor was a stirred, stainless steel batch reactor with a volume of 450 ml and an internal diameter of 50.8 mm.

The product from the reactor 10C was passed to a separator 11C for the removal of gaseous and solid components.

The yields were as follows:

TABLE 3
Yield after second reactor 10C

| | |
|---|---|
| Solid (%) | 1.5 |
| Gas (%) | 2.0 |
| Water (%) | 2.5 |
| Oil (%) | 94 |

The resultant liquid (oil) was subjected to GC-MS analysis with the following results (excluding dodecane):

TABLE 4
GC/MS analysis after second stage

| | Retention | % | |
|---|---|---|---|
| Peak# | time | area | Name |
| 1 | 2.014 | 0.25 | Acetic acid |
| 2 | 2.086 | 1.33 | 2-Butanone |
| 3 | 2.194 | 0.3 | Ethyl Acetate |
| 4 | 2.315 | 1.5 | Methyl propionate |
| 5 | 2.575 | 0.24 | 2-Butanone, 3-methyl- |
| 6 | 2.611 | 1.75 | Cyclohexane |
| 7 | 2.708 | 0.17 | Heptane |
| 8 | 2.88 | 2.2 | 2-Pentanone |
| 9 | 3.011 | 1.17 | 3-Heptanone, 4-methyl- |
| 10 | 3.399 | 1.97 | Cyclohexane, methyl- |
| 11 | 3.591 | 0.32 | Cyclopentane, ethyl- |
| 12 | 3.987 | 0.61 | 2-Pentanone, 3-methyl- |
| 13 | 4.286 | 1.62 | Toluene |
| 14 | 4.531 | 0.31 | Formic acid, heptyl ester |
| 15 | 4.73 | 1.17 | 3-Hexanone |
| 16 | 4.79 | 0.56 | Butanoic acid |
| 17 | 4.873 | 1.61 | Cyclohexanone, 4-methyl- |
| 18 | 5.074 | 0.47 | Octane |
| 19 | 5.775 | 0.21 | Cyclopentane, 1-ethyl-2-methyl-, |
| 20 | 5.925 | 0.36 | Methyl valerate |
| 21 | 6.162 | 0.35 | Cyclohexane, ethyl- |
| 22 | 6.458 | 3.28 | Cyclopentanone, 2-methyl- |
| 23 | 6.546 | 1.31 | Cyclopentanol, 2-methyl-, cis- |
| 24 | 6.701 | 1.16 | Cyclopentanone, 3-methyl- |
| 25 | 6.994 | 0.42 | Butanoic acid, 2-methyl- |
| 26 | 7.251 | 0.87 | Ethylbenzene |
| 27 | 7.572 | 0.5 | Benzene, 1,3-dimethyl- |
| 28 | 8.222 | 5.26 | Cyclohexanol |
| 29 | 8.414 | 0.86 | Octanoic acid |
| 30 | 8.53 | 1 | trans-3,4-Dimethylcyclopentanone |
| 31 | 8.634 | 3.23 | Cyclohexanone |
| 32 | 8.914 | 0.75 | Decane, 2-methyl- |
| 33 | 10.765 | 0.45 | Cyclohexanol, 2-methyl-, trans- |
| 34 | 10.944 | 0.45 | Cyclopentanone, 2-ethyl- |
| 35 | 11.142 | 2.46 | Cyclohexanol, 3-methyl- |
| 36 | 11.3 | 2.73 | Cyclohexanol, 4-methyl-, trans- |
| 37 | 11.395 | 1.11 | Cyclohexanone, 2-methyl- |
| 38 | 11.53 | 1.08 | Cyclohexanone, 3-methyl- |
| 39 | 11.74 | 0.64 | Benzene, propyl- |
| 40 | 11.857 | 1.29 | Cyclohexanone, 4-methyl- |
| 41 | 13.655 | 1.09 | 2-Octenoic acid |
| 42 | 14.557 | 0.56 | Decane |
| 43 | 16.695 | 0.57 | Indane |
| 44 | 16.984 | 0.81 | Cycloheptanone, 2-methyl- |
| 45 | 18.124 | 0.88 | 4-Ethylcyclohexanol |
| 46 | 18.468 | 0.94 | Phenol, 2-methyl- |
| 47 | 18.64 | 0.48 | Cyclohexanone, 3-ethyl- |
| 48 | 19.051 | 0.57 | Cyclohexanone, 4-ethyl- |
| 49 | 19.889 | 1.45 | p-Cresol |
| 50 | 20.159 | 0.59 | Indan, 1-methyl |
| 51 | 20.562 | 0.56 | Phenol, 2-methoxy |
| 52 | 24.878 | 1.88 | Phenol, 2,4-dimethyl- |
| 53 | 25.901 | 1.51 | 4-Propylcyclohexanone |
| 54 | 26.27 | 1.64 | |
| 55 | 26.459 | 0.94 | Phenol, 3-ethyl- |
| 56 | 30.671 | 0.7 | Phenol, 2-ethyl-4-methyl- |
| 57 | 31.306 | 1.01 | Benzene, 1-ethyl-4-methoxy- |
| 58 | 32.746 | 2.46 | |
| 59 | 34.574 | 0.71 | |
| 60 | 35.343 | 9.49 | Tridecane |
| 61 | 37.34 | 0.8 | Benzene, 1-methoxy-4-propyl- |
| 62 | 41.973 | 0.58 | Tetradecane |
| 63 | 48.316 | 2.36 | Pentadecane |
| 64 | 54.221 | 0.76 | Pentadecane |
| 65 | 57.527 | 7.81 | Hexadecane |
| 66 | 59.801 | 1.26 | Heptadecane |
| 67 | 61.218 | 0.44 | 9-Octadecanone |
| 68 | 63.171 | 1.6 | 1-Phenanthrenecarboxaldehyde, |
| | | | 1,2,3,4,4a,9,10,10a-octahydro- |
| | | | 1,4a-dimethyl-7-(1-methylethyl)-, |
| | | | [1S-(1.alpha.,4a.alpha.,10a.beta. |
| 69 | 63.746 | 3.04 | 1-Phenanthrenecarboxaldehyde, |
| | | | 1,2,3,4,4a,9,10,10a-octahydro- |
| | | | 1,4a-dimethyl-7-(1-methylethyl)-, |
| | | | [1S-(1.alpha.,4a.alpha.,10a.beta. |
| 70 | 64.87 | 0.3 | 10,18-Bisnorabieta-5,7,9(10),11,13-pentaene |
| 71 | 64.929 | 0.44 | Hexadecanoic acid, methyl ester |
| 72 | 66.464 | 2.79 | Retene |
| 73 | 67.868 | 1.68 | Methyl dehydroabietate |

The upgraded biofuel blend yield from the second stage was 64.86%. The upgraded bio-oil yield of the second stage liquid product was 22.6% (corresponding to 13.16 wt % of the upgraded biofuel).

### Example 3—Final Refining

The resultant liquid output from the second stage 1C was subject to an optional final refining stage in which the second-stage oil product was introduced into a reactor and reacted with 10 bar H₂ in contact with 5 g of Pt on Al₂O₃ catalyst (supplied by Catal International Limited). The optional final refining stage was intended to further reduce the oxygen content, which is obtained as water by reacting with hydrogen. This is desirable to obtain a product comprising mostly of hydrocarbons. The reactor was heated at 300° C. for 3 hours with stirring at 600 rpm. The reactor was a stirred, stainless steel batch reactor with a volume of 450 ml and an internal diameter of 50.8 mm.

The yields were as follows:

TABLE 5
Yield after final refining

| | |
|---|---|
| Solid (%) | 0 |
| Gas (%) | 1.5 |
| Water (%) | 0 |
| Oil (%) | 98.5 |

The resultant liquid was subjected to GC-MS analysis with the following results (excluding dodecane):

TABLE 6
GC/MS analysis after final refining

| | Retention | % | |
|---|---|---|---|
| Peak# | time | area | Name |
| 1 | 2.083 | 2.75 | n-Hexane |
| 2 | 2.299 | 4.86 | Cyclopentane, methyl- |
| 3 | 2.605 | 7.31 | Cyclohexane |
| 4 | 2.704 | 1.17 | Hexane, 3-methyl- |
| 5 | 2.825 | 1.09 | Cyclopentane, 1,3-dimethyl-, cis- |
| 6 | 2.86 | 0.96 | Cyclopentane, 1,3-dimethyl-, cis- |
| 7 | 2.895 | 1.48 | Cyclopentane, 1,2-dimethyl- |
| 8 | 3 | 2.45 | Heptane |
| 9 | 3.394 | 11.72 | Cyclohexane, methyl- |
| 10 | 3.581 | 2.11 | Cyclopentane, ethyl- |
| 11 | 3.675 | 0.65 | Cyclopentane, 1,2,4-trimethyl- |
| 12 | 3.821 | 0.35 | Cyclopentane, 1,2,3-trimethyl-, |
| | | | (1.alpha.,2.alpha.,3.beta.) |
| 13 | 4.357 | 0.72 | Butane, 2,2, 3-trimethyl- |
| 14 | 4.505 | 2.85 | Cyclohexane, 1,3-dimethyl-, cis- |
| 15 | 4.545 | 0.6 | |
| 16 | 4.756 | 1.03 | Cyclopentane, 1-ethyl-3-methyl- |
| 17 | 4.817 | 0.95 | Cyclopentane, 1-ethyl-3-methyl- |
| 18 | 4.852 | 0.95 | Cyclopentane, 1-ethyl-2-methyl-, cis- |
| 19 | 5.02 | 1.26 | Cyclohexane, 1,3-dimethyl- |
| 20 | 5.055 | 1.73 | Octane |
| 21 | 5.237 | 1.5 | Cyclohexane, 1,3-dimethyl-, trans- |
| 22 | 5.76 | 0.22 | Cyclopentane, 1-ethyl-2-methyl-, cis- |
| 23 | 5.99 | 0.68 | Cyclohexane, 1,2-dimethyl-, cis- |
| 24 | 6.14 | 7.73 | Cyclohexane, ethyl- |
| 25 | 6.776 | 0.66 | Cyclohexane, 1,3,5-trimethyl- |
| 26 | 7.609 | 0.9 | Octane, 3-methyl- |
| 27 | 7.715 | 0.56 | |
| 28 | 8.191 | 0.9 | Cyclopentane, 1-methyl-2-propyl- |
| 29 | 8.285 | 2.71 | 1-Ethyl-3-methylcyclohexane (c,t) |
| 30 | 8.365 | 1.02 | Cyclohexane, 1-ethyl-4-methyl-, trans- |
| 31 | 8.56 | 0.52 | |
| 32 | 8.893 | 1.44 | Nonane |
| 33 | 9.177 | 1.37 | 1-Ethyl-4-methylcyclohexane |
| 34 | 9.795 | 0.94 | Cyclopentylcyclohexane |
| 35 | 10.347 | 6.38 | Cyclohexane, propyl- |
| 36 | 10.586 | 0.65 | Cyclopentane, butyl- |
| 37 | 12.74 | 0.78 | 5-Ethyl-1-nonene |
| 38 | 13.345 | 1.53 | Cyclohexane, 1-methyl-2-propyl- |
| 39 | 13.499 | 1.17 | Cyclohexane, 1-methyl-2-propyl- |
| 40 | 13.619 | 0.61 | |
| 41 | 14.516 | 0.77 | Decane |
| 42 | 16.415 | 0.93 | Cyclohexane, butyl- |
| 43 | 17.776 | 1.03 | Naphthalene, decahydro- $$ |
| | | | Bicyclo[4.4.0]decane |
| 44 | 20.325 | 0.97 | Cyclohexane, 1-ethyl-2-propyl |
| 45 | 35.236 | 5.38 | Tridecane |
| 46 | 41.908 | 0.54 | Tetradecane |
| 47 | 48.256 | 1.67 | Pentadecane |
| 48 | 54.194 | 0.53 | Pentadecane |
| 49 | 57.499 | 5.05 | Hexadecane |
| 50 | 59.781 | 0.68 | Nonane, 3-methyl-5-propyl- |
| 51 | 61.63 | 1.19 | |
| 52 | 63.148 | 1.31 | 1-Phenanthrenecarboxaldehyde, |
| | | | 1,2,3,4,4a,9,10,10a-octahydro- |
| | | | 1,4a-dimethyl-7-(1-methylethyl)-, |
| | | | [1S-(1.alpha.,4a.alpha.,10a.beta. |
| 53 | 64.07 | 0.68 | |

The upgraded biofuel blend yield from the final stage was 63.89%. The upgraded bio-oil yield of the final stage liquid product was 22% (corresponding to 13.0 wt % of the upgraded biofuel blend).

### Example 3A—Overall Characteristics

The overall characteristics of the bio-oil starting material, dodecane solvent, traditional kerosene and the product of the process (hereinafter (biofuel or biokerosene) are as follows:

| | | | Bio- | |
|---|---|---|---|---|
| | Bio-oil | Dodecane | kerosene | Kerosene |
| Elemental | | | | |
| composition | | | | |
| C (wt %) | 43.3 ± 0.3 | 84.4 ± 0.5 | 84.7 ± 1.9 | 84.5 ± 0.5 |
| H (wt %) | 6.01 ± 0.6 | 15.0 ± 0.1 | 15.0 ± 0.3 | 15.5 ± 0.5 |
| N (wt %) | 0.2 ± 0.01 | 0.0 ± 0.0 | 0.2 ± 1.3 | 0.0 ± 0.0 |
| O (wt %) by | 50.4 ± 0.7 | 0.2 ± 0.1 | 0.2 ± 0.02 | 0.0 ± 0.0 |
| difference | | | | |
| H/C ratio | 0.14 | 0.18 | 0.18 | 0.18 |
| O/C ratio | 1.16 | 0 | 0 | 0 |
| Proximate analysis | | | | |
| Ash (%) | 1.52 ± 0.25 | 0 | 0 | 0 |
| HHV (MJ/Kg) | 21.44⁵ | 47.84⁶ | 46.97 | 46.20⁶ |
| Physical-chemical | | | | |
| analysis | | | | |
| Water content (%) | 3.1 ± 0.8 | 0 | 0.5 ± 0.2 | 0 |
| Acid number | | | 0.3786 | |
| (mgKOH/g) | | | | |
| pH value | 2.4 ± 0.3 | — | — | — |
| Density (g/cm³) at | 1.300 | 0.7489 | 0.7517 | 0.800 |
| 25° C. | | | | |
| Viscosity at 40° C. | | | 1.541 | |
| (cSt/s) | | | | |
| Flash point | | | 110.66 | |
| Fire point | | | 114.66 | |
| Burning speed (g/min) | — | — | 0.145 | 0.186 |

⁵Calculated using the Kistler Instruments Ltd (Hampshire, UK) KiBox (RTM) powertrain analysis system
⁶Literature

The analyses clearly show the reduction in oxygen and water as a result of the refining process, as well as the reduction of solids as measured by the ash content on combustion.

It will be appreciated that the biokerosene can be used as a ‘drop in’ replacement for kerosene and/or can be blended with fuels to augment that fuel. In either case, the biokerosene of the invention enables a reduction in the use of fossil-fuels

### Example 4—Engine Performance

In order to determine how the upgraded fuel performed in engines a series of tests were conducted. In each test the upgraded liquid fuel was further blended with kerosene to give a 10 wt % upgraded biofuel content. The performance of the blended fuel was compared to that of diesel and 100% kerosene.

In each graph the left hand bar is diesel, the middle bar is blended fuel with 10 wt % upgraded biofuel content in kerosene and the right hand bar is kerosene.

### Example 4A—Brake Specific Fuel Consumption (BSFC)

In order to determine the BSFC an engine fueled with the respective fuels was run at 1500 rpm and at different torques.

BSFC is calculated as FC/T·N′, where FC is fuel consumption, T is torque and N′ is engine speed in rads per second.

The results, which are shown in FIG. 2, demonstrate that the blended fuel with 10 wt % upgraded biofuel content in kerosene has a comparable BSFC to diesel and kerosene over the torque range of the experiment.

### Example 4B—Brake Thermal Efficiency (BTE)

In order to determine the BTE an engine fueled with the respective fuels was run at 1500 rpm and at different torques.

BTE is calculated as (2·π·N·T/60)/(mass flow rate of fuel×calorific value of fuel), where T is torque and N is the rpm.

The results, which are shown in FIG. 3, demonstrate that blended biofuel appears to have higher, or at least as high BTE than kerosene across the entire torque range.

### Example 5—Engine Combustion

In order to determine how the blended fuel with 10 wt % upgraded biofuel content in kerosene performed in engines a series of tests were conducted. In each test blended fuel with 10 wt % upgraded biofuel content in kerosene (hereinafter blended biofuel). The performance of the blended biofuel was compared to that of diesel and 100% kerosene.

### Example 5A—in Cylinder Pressure

In order to determine the in-cylinder pressure an engine fueled with the respective fuels was run at 1500 rpm and 60 Nm of torque.

The results, which are shown in FIG. 4, indicate that the blended biofuel (4B) may have generated slightly higher in-cylinder pressures at low crank angles but generated in cylinder pressures equivalent to those of the other fuels at other crank angles.

### Example 5B—Heat Release Rate

In order to determine the heat release rate an engine fueled with the respective fuels was run at 1500 rpm and 60 Nm of torque.

The results, which are shown in FIG. 5, indicate that the heat release rate for diesel (5A), blended biofuel (5B) and kerosene (5C) are different at different crank angles.

### Example 5C—Cumulative Heat Release Rate

In order to determine the cumulative heat release rate an engine fueled with the respective fuels was run at 1500 rpm and 60 Nm of torque.

The results, which are shown in FIG. 6, indicate that the blended biofuel (6B) may have generated slightly higher heat release rates across the cycle and that the release rate of kerosene is less than that of diesel, indicating the blended biofuel component is releasing greater heat than kerosene.

### Example 6—Emissions

In order to determine how the blended biofuel performed in engines a series of tests were conducted. In each test blended fuel with 10 wt % upgraded biofuel content in kerosene (hereinafter blended biofuel). The performance of the blended biofuel was compared to that of diesel and 100% kerosene.

In each graph the left hand bar is diesel, the middle bar is blended biofuel and the right hand bar is kerosene.

FIG. 7 shows the emissions of hydrocarbons. The results show that blended biofuel emitted fewer hydrocarbons than diesel or kerosene.

FIG. 8 shows the emissions of carbon monoxide. The results show that blended biofuel typically emitted less CO than diesel and kerosene.

FIG. 9 shows the emissions of carbon dioxide. The results show that blended biofuel typically emitted similar amounts of CO₂ than diesel and kerosene.

FIG. 10 shows the emissions of nitrogen monoxide. The results show that blended biofuel typically emitted similar NO than kerosene and emitted broadly similar amounts than diesel.

FIG. 11 shows the emissions of smoke. The results show that blended biofuel typically emitted less smoke than diesel and kerosene.

The emissions tests clearly show that even at a blend of 10 wt % upgraded bio-oil can lead to significant emissions improvements.

1-25. (canceled)

26. A two-stage method for producing a biofuel, the method comprising:
a first stage of heating bio-oil, organic solvent and non-oxygenating gas in the presence of a solid catalyst;
providing a liquid output from the first stage; and
a second stage of heating an organic liquid component derived from the liquid output and non-oxygenating gas in the presence of a solid catalyst.

27. A method according to claim 26, comprising providing:
the bio-oil and the organic solvent in weight ratios (wt %) of from 10:90 to 90:10;
and/or
the organic solvent in weight excess of the bio-oil.

28. A method according to claim 26, wherein the first stage comprises a subsequent separating stage to separate the output into gaseous, solid and the liquid output.

29. A method according to claim 28 wherein the subsequent separating stage comprises passing the output through a filter.

30. A method according to claim 26, comprising dewatering the liquid output from the first stage to form the organic liquid component.

31. A method according to claim 26, wherein the second stage comprises a subsequent separating stage to separate the output into a gaseous component and/or a solid component and an upgraded liquid component.

32. A method according to claim 31, wherein the subsequent separating stage comprises passing the output through a filter.

33. A method according to claim 31, comprising mixing the upgraded liquid component with a fuel to form a blended biofuel.

34. A method according to claim 33, comprising mixing the upgraded liquid component and fuel at mixing ratios of 5-95 wt % upgraded liquid component to 95-5 wt % fuel.

35. A method according to claim 26 comprising:
providing as the non-oxygenating gas of the first and/or second stage hydrogen, nitrogen, argon, helium or mixtures of the same; and/or
providing the non-oxygenating gas at pressures of from 5 to 25 bar (0.5-2.5 MPa).

36. A method according to claim 26, comprising providing as the organic solvent a liquid hydrocarbon with from 8 to 20 carbons.

37. A method according to claim 26, comprising providing as the organic solvent an aliphatic hydrocarbon.

38. A method according to claim 26, wherein the first stage comprises heating to a temperature of 100-250° C. for a first time period and heating from 250-500 for a second time period.

39. A method according to claim 38, comprising heating for the first time period for 1 to 5 hours and/or heating for the second time period for 1 to 5 hours.

40. A method according to claim 26, wherein the second stage comprises heating to a temperature of 250-500° C. for from 1 to 5 hours.

41. A method according to claim 26, comprising in the first stage providing, as the solid catalyst, platinum metal.

42. A method according to claim 26, comprising in the second stage, providing, as the solid catalyst, platinum metal.

43. An apparatus for producing a blended biofuel, the apparatus comprising
a first heatable reactor and a first separator
a second heatable reactor and a second separator,
the first separator being arranged to separate the products of the first reactor into liquid, solid and gaseous components,
the second separator being arranged to separate the products of the second reactor into liquid, solid and gaseous components,
a liquid separator to separate the liquid component from the first separator into an aqueous component and an organic component and
means to convey the organic component to the second reactor.

44. An apparatus according to claim 43, wherein:
the first reactor comprises a bio-oil supply line and an organic solvent supply line and a non-oxygenating gas supply line; and/or
said means to convey the organic component to the second reactor comprises an organic component supply line; and/or
the second reactor comprises a non-oxygenating gas supply line; and/or
the apparatus further comprises means to mix the liquid output of the second separator with a fuel to form a blended biofuel.

45. A biofuel, the biofuel comprising a mixture of a bio-oil derived component and a liquid hydrocarbon solvent, wherein the biofuel comprises from 5-95 wt % bio-oil derived component and from 95 to 5 wt % a hydrocarbon solvent, water and oxygenated compounds, and wherein the water content is less than 1 wt % and the oxygen content is less than 1 wt %.
